(19) United States
(12) Patent Application Publication
(10) Pub. No.: US 2009/0117397 A1
(43) Pub. Date: May 7, 2009

(54) METHODS AND APPARATUS FOR RECYCLING TIRES AND REINFORCING RUBBER BASED PRODUCTS

(76) Inventor: Jose Manuel Ballina, Guanajuato (MX)

Correspondence Address: PATTERSON & SHERIDAN, L.L.P., 3040 POST OAK BOULEVARD, SUITE 1500, HOUSTON, TX, 77056, US

(21) Appl. No.: 11/933,828

(22) Filed: Nov. 1, 2007

(51) Int. Cl. B32B 15/08; C08J 11/04

(52) U.S. Cl. 428/461; 521/40.5

(57) ABSTRACT

The present invention generally relates to recycled rubber based products that are reinforced with steel components from tires. Examples of the recycled rubber based products include mud flaps, mats, tile, bumpers, pallets, and posts. In addition, the present invention generally relates to a method of reinforcing such rubber based products with steel components from tires and recycling the steel components from tires.

### BACKGROUND OF THE INVENTION

1. Field of the Invention

Embodiments of the present invention are directed to apparatus and methods for recycling tires into rubber based products. Embodiments of the present invention also are directed to apparatus and methods for reinforcing rubber based products with steel tire components.

2. Description of the Related Art

Traditionally, a large amount of the raw materials used for manufacturing rubber based products such as mud flaps, mats, bumpers, pallets, and posts come from scrap or textile friction generated by tire manufactures, including defective tires. Other raw materials include plastics and uncured rubber. To produce products from these types of raw materials, however, require a thorough examination of the material for contaminants such as steel. Certain steel contaminants are extremely hard to separate from the raw material and can disrupt the manufacturing process, as well as diminish the quality of particular rubber based products. As a result, the contaminated raw materials are normally dumped into landfills or burned in incinerators.

A specific example of such contaminated raw material is the “green tire,” which is a fully assembled tire that was considered defective prior to being cured and formed into a safe and sellable product. The basic components of a green tire can be broken down into a rim, a tire floor, a tire floor liner, a tread, a steel belt, sidewalls, and bead wires. In particular, the bead wire and steel belt contain steel filaments that are difficult to separate from the uncured rubber and normally cannot be used as raw materials for making rubber based products. Thus the steel bead wire and steel belt are discarded or incinerated.

The dumping and burning of these raw materials increase unfriendly environmental practices; for example, requiring more landfills, which are hazardous to maintain, and adding pollutants to the air, which enhance global warming. Although these materials can be burned in a controlled environment to reduce air toxins and produce energy, the pollution generated from the burning is not completely eliminated. In addition, the use of recycled rubber materials to produce rubber based products is a great substitute for products traditionally made out of wood, such as pallets and posts, which contribute significantly to deforestation.

A basic rubber recycling process includes the following steps: receiving bales of raw material from tire factories or other suppliers, inspecting the raw material for contaminants, cutting up the material first with a large guillotine and then further chopping the material into small particles, milling the particles on a roll mill to obtain rubber blanks of certain thicknesses, shapes, and sizes, and then curing the rubber blanks in a heating press. The rubber blanks can be formed into a variety of different products as mentioned above. In addition, curing the rubber blanks in a heating press is a form compression molding that can be used with templates to emboss the blanks with letters, numbers, or images that can be painted.

Textile friction is a common material that is used to make many rubber based products such as mud flaps, mats, bumpers, pallets, and posts because it has excellent weather resistance and its textile cords reinforce the already good tear resistance of the rubber itself. Nevertheless, these rubber based products can be subjected to extreme wear from volatile weather conditions. Hostile circumstances, such as strong wind forces, severe temperature shifts, and rough surface contacts, also can cause these products to bend, break, and tear.

To prevent fracture and increase durability, some rubber based products are reinforced with filler materials. However, reinforcing a product with filler materials can add to the cost of the product and increase the complexity of the manufacturing set up. A manufacturer would have the additional burdens of purchasing or obtaining the additional reinforcing raw materials, forming the materials to the necessary shapes and sizes, and integrating the materials safely and efficiently into the products.

Therefore, there is a need for a method to recycle rubber raw materials that contain steel components to help the environment and reduce the pollution caused by dumping or burning such materials. There is also a need for stronger and more durable recycled rubber based products. There is even more a need for a cost effective method of reinforcing rubber based products, without adding to the complexity of the manufacturing process.

### SUMMARY OF THE INVENTION

The present invention generally relates to rubber based products that are reinforced with steel components from tires. An embodiment of the present invention comprises a rubber blank and a portion of a tire incorporated into the rubber blank, wherein the portion of the tire contains steel.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a perspective view of a basic tire.

FIG. 2 is a perspective view showing a rubber blank reinforced with a section of a steel belt from a tire.

FIG. 3 is a perspective view showing a rubber blank reinforced with a steel bead wire from a tire.

### DETAILED DESCRIPTION

Embodiments of the present invention include rubber based products that are reinforced with portions of a tire that contain steel. Embodiments of present invention also include a method of reinforcing rubber based products with tire components that contain steel. Embodiments of the present invention further include a method of recycling tire components that are normally dumped into landfills or burned in incinerators, thereby saving valuable land space and reducing air pollution. Some examples of rubber based products include, but are not limited to, mud flaps for vehicles, mats such as floor mats, door mats, or vehicle mats, floor tile for gym and work out floors, factory floors, or building floors, bumpers for vehicles, pallets for storage or moving items, and posts such as street posts, vehicle or pedestrian barriers, or construction posts. These rubber based products are produced from natural or synthetic rubber, rubber scrap, textile friction, and tires.

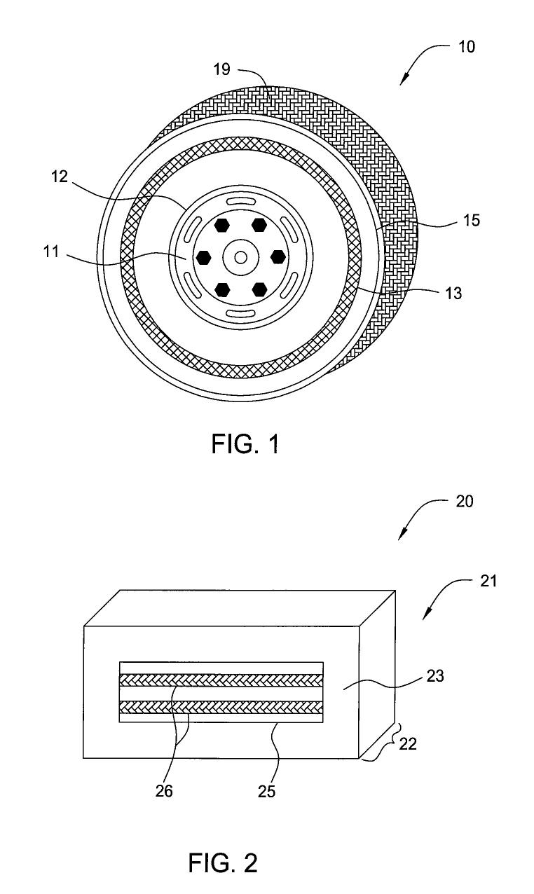

FIG. 1 is a perspective view of a tire 10. The basic components of a tire include a rim 11, a bead wire 12, sidewalls 13, a steel belt 15, and a tread 19. The steel belt 15 generally consists of woven steel fabrics. Other components of a tire may include textile friction, a tire floor, and a tire floor liner. The main steel components of the tire are the bead wire 12 and the steel belt 15. Because the uncured rubber is extremely hard to separate from the steel bead wire 12 and the steel belt 15, these components are normally discarded or burned when recycling a “green tire.”

A “green tire” is a tire that is considered defective for some reason and has not yet been cured or vulcanized. Green tires are usually fully assembled, but can be partially assembled, prior to being marked as defective or cured in a heating process. Green tires are a good source of raw materials for producing and reinforcing rubber based products.

In one embodiment, a tire is fully recycled into a reinforced rubber based product. In an optional embodiment, particular components of a tire can be combined with other raw materials to produce and reinforce rubber based products. In an optional or alternative embodiment, portions of particular components of a tire can be combined with other raw materials to produce and enhance the qualities of rubber based products.

FIG. 2 shows a reinforced rubber based product 20. A rubber blank 21 is produced from recycled raw materials and has a section 25 of a steel tire component pressed into the center of it. For example, the section 25 and can be placed on top of the rubber blank 21 at a desired location, and both of the pieces can be placed in a heated press and pressed together so that the section 25 is incorporated into the rubber blank 21 and the rubber is cured. The section 25 is a longitudinal strip from a steel belt that is pressed into the center of the rubber blank 21 so that the section 25 is flush with a surface 23 of the rubber blank 21. In addition, woven steel fabrics 26 from the steel belt lie in a generally horizontal direction. If the rubber blank 21 is bended, twisted, stretched, or ripped along the section 25, the steel fabrics 26 will enhance the rubber blank's resistance to such movements. Therefore, the section 25 reinforces the rubber blank 21 and makes it stronger and more durable against external forces.

The section 25 may be positioned in the rubber blank 21 so that it is flush with any surface, corner, or edge of the blank, or so that it is completely disposed within the thickness 22 of the blank. The section 25 may also be raised so that it sits on the surface 23 of the rubber blank 21. The section 25 may also be placed in a position where the steel fabrics lie in a vertical direction, at an angle, perpendicular to the blank, or in multiple directions. More than one section 25 may be used and positioned at various locations or stacked throughout the rubber blank 21. Numerous combinations of the above described features can be utilized to add to the rubber blank's resilience.

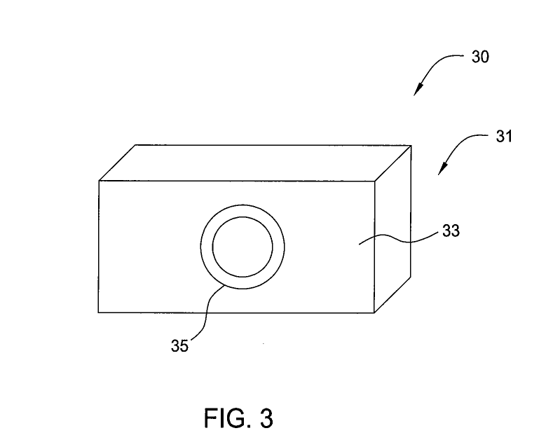

FIG. 3 shows another reinforced rubber based product 30. The rubber blank 31 is reinforced with a steel bead wire 35 from a tire. The steel bead wire 35 is pressed into the center of the rubber blank 31. Similar to the section 25 in FIG. 2, the steel bead wire 35 may be placed at numerous positions, locations, and directions within or on the rubber blank 21. Also, portions of a steel bead wire or multiple steel bead wires may be used to reinforce a rubber blank as needed. The wire reinforcement will also avoid the sailing of the rubber blank. For example, if the rubber based product is a mud flap positioned on a vehicle, the reinforcement will make help it stand vertical in spite of the wind forces generated by the movement of the vehicle.

In alternative embodiments of both FIG. 2 and FIG. 3, the rubber blank 21 and 31 may be reinforced with combinations of a steel belt, a steel wire bead, and other traditional filler materials, such as textile cords, heavy duty wire, etc. In addition, the rubber blank may have a sheet of polymer, that contains a printed image, attached to it (not shown). Finally, the rubber blank may be formed into a mud flap, mat, tile, bumper, pallet, post, or other rubber based product.

As described in the foregoing, a procedure for reinforcing a rubber blank will be discussed. Consequently, a method for recycling tires also will be discussed. A method of reinforcing a rubber blank involves undressing a tire into components, masticating some of the components into a mixture, forming the mixture into a rubber blank, and incorporating the steel components from the tire into the rubber blank.

Undressing a tire into components involves separating the tire into pieces that can be used as recyclable raw materials. The process also involves removing the steel components of the tire so that they can be used as reinforcing materials. The components of a tire may vary but generally include a rim, steel bead wires, sidewalls, textile friction, a steel belt, a tire floor, a tire floor liner, and a tread. Stripping or tearing out the tire components can be done manually, automatically, or by a combination of both a manual and automated process. The use of solvents and cutting devices can be used to facilitate the separation process, particularly for the removal of the steel bead wires and steel belt.

Some of the tire components can be refined into small pieces or particles by a series of cutting and chopping machinery. Initial cutting of the raw material can be performed by large guillotines, if necessary, after which chopping units can be used to chew up the material into small particles. These small pieces or particles may be used to form rubber blanks and other rubber based products. Alternatively, these small pieces or particles can be mixed with other raw materials, such as a textile friction, prior to being converted into blanks and products. Fabric cords in the textile friction help increase the durability of the rubber.

Rubber blanks can be formed from the raw materials in a variety of ways. The material may be conveyed through a rolling mill to flatten it into sheets of varying thicknesses and lengths, after which the sheets may be cut into rubber blanks of desired shapes and sizes. These rubber blanks constitute the foundation of many rubber based products.

The steel bead wires and steel belt from a tire can be pressed into the rubber blanks to reinforce the blanks against external forces. On example includes, but is not limited to, a rubber blank is laid on a template and a section of a steel belt or bead wire is placed on top of the rubber blank. The template, rubber blank, and section are then forced together in a heating press that presses the section into the rubber blank and vulcanizes the rubber into the shape of the template. Multiple sections of a steel belt or bead wire can be placed at different locations on the rubber blank and in an array of positions, prior to being incorporated into the blank.

Additionally, multiple rubber blanks or sections of rubber blanks can be used to form a rubber based product. For example, two rubber blanks can be laid on a template, with a steel tire component placed on top of or between the rubber blanks, prior to being inserted into a heating press. In another example, a small piece a rubber blank can be placed on top of another larger rubber blank, along with a steel tire component, and pressed together to add rubber to a certain part of the final product. In a further example, a rubber blank can be formed with extensions or protrusions stemming from the rubber blank, and the rubber blank or the extensions may be reinforced with a steel tire component.

In an optional embodiment, sections of a steel tire component can be encased or laminated with a rubber blank, other rubber material, or textile friction, wrapped with a shrink wrapping device, and placed in a heated compression device, such as an autoclave, to form a reinforced rubber based post or other similar products.

In an optional or alternative embodiment, a sheet of polymer can be attached to a rubber blank. A surface of the rubber blank is treated with a chemical mixture. The chemical mixture is spread or sprayed onto the surface of the rubber blank to loosen and fragment the chemical bonds along the surface of the rubber. The break up of these chemical bonds will enable the surface to create new chemical bonds with a later applied bonding agent. The chemical mixture may comprise of a halogen or a chlorine component and may be produced in small batches.

After the surface of the rubber blank is treated with the chemical mixture, a bonding agent is applied to the treated surface. The bonding agent may even be applied to the sheet of polymer. The sheet of polymer is then arranged on top of the treated rubber surface, with the bonding agent in between the two surfaces, and the sheet of polymer and rubber blank are pressed together. The bonding agent creates chemical bonds with the rubber blank and the polymer sheet. It is preferred that the sheet of polymer is attached to the rubber blank within a day after the surface is treated with the chemical mixture. The image may be printed on the sheet of polymer after it is attached to the rubber blank, but it optionally may be printed on the sheet of polymer before attachment. In addition to being printed, the image can be painted, stamped, drawn or placed on the sheet in a variety of other ways.

While the foregoing is directed to embodiments of the present invention, other and further embodiments of the invention may be devised without departing from the basic scope thereof, and the scope thereof is determined by the claims that follow.

1. A recycled rubber apparatus, comprising:
a rubber blank; and
a portion of a tire incorporated with the rubber blank, wherein the portion of the tire contains steel.

2. The apparatus of claim 1, wherein a sheet of polymer is attached to the rubber blank.

3. The apparatus of claim 2, wherein an image is printed on the sheet of polymer.

4. The apparatus of claim 1, wherein the rubber blank is a mud flap.

5. The apparatus of claim 1, wherein the rubber blank is one or more of a mat, a tile, a bumper, a pallet, and a post.

6. The apparatus of claim 1, wherein the portion of the tire is a steel bead.

7. The apparatus of claim 1, wherein the portion of the tire is a section of a steel belt.

8. A method of reinforcing a rubber blank, comprising:
undressing a tire into components, the components comprising textile friction, rubber, and steel;
masticating the textile friction and rubber to form a mixture;
forming the mixture into a blank;
incorporating the steel with the blank to form a reinforced blank.

9. The method of claim 8, wherein the reinforced blank comprises a mud flap.

10. The method of claim 8, wherein the reinforced blank comprises one or more of a mat, a tile, a bumper, a pallet, and a post.

11. The method of claim 8, further comprising:
treating a surface of the reinforced blank with a chemical mixture, wherein the chemical mixture comprises a halogen;
applying a bonding agent to the treated surface; and
connecting a sheet of polymer and the treated surface together.

12. The method of claim 11, wherein an image is printed on the sheet of polymer.

13. A method of recycling tires, comprising:
undressing a tire into its components, the components comprising a bead wire, a steel belt, a tread, and sidewalls;
combining one or more of the tread and sidewalls with a textile friction;
forming a rubber blank out of one or more of the tread, sidewalls, and textile friction; and
pressing a portion of one or more of the bead wire and the steel belt and the rubber blank together.

14. The method of claim 13, further comprising forming the rubber blank into a mud flap.

15. The method of claim 13, further comprising forming the rubber blank into one or more of a mat, a tile, a bumper, a pallet, and a post.

16. The method of claim 13, further comprising attaching an image to the rubber blank.

17. The method of claim 13, further comprising:
treating a surface of the rubber blank with a chemical mixture, wherein the chemical mixture comprises a halogen;
applying a bonding agent to the treated surface; and
pressing a sheet of polymer and the treated surface together.

18. The method of claim 17, wherein an image is printed on the sheet of polymer.

19. A method of reinforcing a rubber based product, comprising:
undressing a tire into components, the components comprising textile friction, rubber, and steel;
masticating one or more of the textile friction and rubber to form a mixture;
covering the steel with the mixture to form a mold;
wrapping the mold with a shrink wrap; and
placing the mold with the shrink wrap in an autoclave to form a reinforced rubber based product.

20. The method of claim 19, further comprising:
treating a surface of the reinforced rubber based product with a chemical mixture, wherein the chemical mixture comprises a halogen;
applying a bonding agent to the treated surface; and
pressing a sheet of polymer and the treated surface together.

21. The method of claim 20, wherein an image is printed on the sheet of polymer.
